(19) United States
(12) Patent Application Publication
(10) Pub. No.: US 2024/0430907 A1
(43) Pub. Date: Dec. 26, 2024

(54) METHODS AND APPARATUSES FOR DETERMINING TRANSMISSION CONFIGURATION INDICATOR STATE

(71) Applicant: Nokia Technologies Oy, Espoo (FI)

(72) Inventors: Sami-Jukka HAKOLA, Oulu (FI); Juha Pekka KARJALAINEN, Oulu (FI); Mihai ENESCU, Espoo (FI)

(21) Appl. No.: 18/692,929

(22) PCT Filed: Sep. 27, 2022
(86) PCT No.: PCT/EP2022/076743

§ 371 Date: Mar. 18, 2024

Related U.S. Application Data
(60) Provisional application No. 63/255,725, filed on Oct. 14, 2021.

(51) Int. Cl. H04W 72/232; H04L 1/1812; H04W 72/0446

(52) U.S. Cl. CPC H04W 72/232; H04L 1/1812; H04W 72/0446

(57) ABSTRACT

Systems, methods, apparatuses, and computer program products for determining transmission configuration indicator (TCI) state are provided. One method may include detecting, by a user equipment, one or more downlink control information (DCIs), and determining, by the user equipment, at least one of the one or more DCIs. Acknowledgement information for the determined at least one of the one or more DCIs is transmitted in a same symbol, in a same slot or in a same uplink channel. The method may also include determining, by the user equipment, a first TCI state indicated in a first DCI, where the first DCI is latest in time among the determined at least one of the one or more DCIs, and applying, by the user equipment, the first TCI state.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for determining transmission configuration indicator (TCI) state.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to a method that includes detecting, by a user equipment, one or more downlink control information (DCIs), determining at least one of the downlink control information (DCIs) where acknowledgement information for the determined at least one of the one or more DCIs is transmitted in a same symbol, in a same slot or in a same uplink channel, determining a first transmission configuration indicator (TCI) state indicated in a first downlink control information (DCI) where the first DCI is latest in time among the determined at least one of the one or more DCIs, and applying, by the user equipment, the determined first transmission configuration indicator (TCI) state.

An embodiment may be directed to an apparatus including at least one processor and at least one memory comprising computer program code. The at least one memory and computer program code configured, with the at least one processor, to cause the apparatus at least to perform: detecting one or more downlink control information (DCIs), determining at least one of the one or more downlink control information (DCIs) where acknowledgement information for the determined at least one of the one or more DCIs is transmitted in a same symbol, in a same slot or in a same uplink channel, determining a first transmission configuration indicator (TCI) state indicated in a first downlink control information (DCI) where the first DCI is latest in time among the determined at least one of the one or more DCIs, and applying the first transmission configuration indicator (TCI) state.

An embodiment may be directed to an apparatus that includes means for detecting one or more downlink control information (DCIs), means for determining at least one of the downlink control information (DCIs) where acknowledgement information for the determined at least one of the one or more DCIs is transmitted in a same symbol, in a same slot or in a same uplink channel, means for determining a first transmission configuration indicator (TCI) state indicated in a first downlink control information (DCI) where the first DCI is latest in time among the determined at least one of the one or more DCIs, and means for applying the first transmission configuration indicator (TCI) state.

An embodiment may be directed to a computer readable medium comprising program instructions stored thereon for performing a process that includes detecting one or more downlink control information (DCIs), determining at least one of the one or more downlink control information (DCIs) where acknowledgement information for the determined at least one of the one or more DCIs is transmitted in a same symbol, in a same slot or in a same uplink channel, determining a first transmission configuration indicator (TCI) state indicated in a first downlink control information (DCI) where the first DCI is latest in time among the determined at least one of the one or more DCIs, and applying the first transmission configuration indicator (TCI) state.

### BRIEF DESCRIPTION OF THE DRAWINGS

For proper understanding of example embodiments, reference should be made to the accompanying drawings, wherein:

FIG. 1 illustrates an example of physical downlink shared channel (PDSCH) time domain allocation, according to one example;

FIG. 2 illustrates an example of time division duplex (TDD) pattern configuration, according to an example;

FIG. 3 illustrates an example of flexible hybrid automatic repeat request (HARQ) acknowledgement (ACK)/negative-acknowledgement (NACK) timing, according to one example;

FIG. 4 illustrates the ambiguity in which TCI indication the UE applies for the same application time, according to an embodiment;

FIG. 5 illustrates an example flow diagram of a method, according to certain embodiments;

FIG. 6A illustrates an example block diagram of an apparatus, according to an embodiment; and

FIG. 6B illustrates an example block diagram of an apparatus, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for solving ambiguity in beam application time, for example in unified transmission configuration indicator (TCI) framework, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Certain example embodiments discussed herein may relate to new radio (NR) physical layer development. For example, some embodiments may be configured to address ambiguity in beam switching procedure in 3GPP Release-17 unified TCI framework.

The objectives for multi-beam enhancements may include extending support for enhancement of multi-beam operation, targeting frequency range 2 (FR2) while also applicable to frequency range 1 (FR1). This may include identifying and specifying features to facilitate more efficient (lower latency and overhead) downlink (DL)/uplink (UL) beam management for intra-cell and inter-cell scenarios to support higher UE speed and/or a larger number of configured TCI states, such as common beam for data and control transmission/reception for DL and UL (e.g., for intra-band carrier aggregation), unified TCI framework for DL and UL beam indication, and enhancement to signaling mechanisms for the above features to improve latency and efficiency with more usage of dynamic control signaling (as opposed to radio resource control). For inter-cell beam management, a UE can transmit to or receive from a single cell (i.e., serving cell does not change when beam selection is done). This includes layer 1 (L1)-only measurement/reporting (i.e., no L3 impact) and beam indication associated with cell(s) with any physical cell ID(s). The beam indication may be based on Release-17 unified TCI framework. The same beam measurement/reporting mechanism can be reused for inter-cell multiple transmission-reception point (mTRP). Further objectives may include identifying and specifying features to facilitate UL beam selection for UEs equipped with multiple panels, considering UL coverage loss mitigation due to maximum permissible exposure (MPE), based on UL beam indication with the unified TCI framework for UL fast panel selection.

In the unified TCI frame being developed, the UE may be configured either joint DL/UL TCI states or separate DL and UL TCI states for the DL signal/channel reception and UL signal/channel transmission, respectively. The UE may be activated up to N (e.g., N could be 8) joint or separate DL and UL TCI states from which one is a so-called indicated TCI state. In the case of joint DL/UL indicated TCI state, the UE may use the single TCI state to determine DL reception parameters and the UL transmission parameters, like receive beam in downlink and transmit beam in uplink. While, in the case of separated DL and UL TCI states, the UE has one indicated TCI codepoint at a time that comprises TCI state for DL and TCI for UL to determine receive beam in downlink and transmit beam in uplink, respectively.

On the unified TCI framework, the following aspects are provided. A common TCI state (a.k.a. indicated TCI) for a set of signals and channels at a time. The TCI state can be joint DL/UL, separate DL TCI state and separate UL TCI state. RRC configures set (or pool) of joint and/or separate TCI states. Medium access control (MAC) activates a number (e.g., 8) of joint and/or separate TCI states. Before the first indication, the first activated TCI state is the current indicated TCI state. The downlink control information (DCI) may indicate one of the activated TCI states to be the indicated TCI state (which may be a common TCI state).

On the DCI-based TCI state indication, the following aspects are provided. DCI format 1_1/1_2 with and without DL assignment may be used to carry the TCI state indication. The indication may be confirmed by hybrid automatic repeat request (HARQ) acknowledgement (ACK) by the UE. For application time of the beam indication, the first slot that is at least X ms or Y symbols after the last symbol of the acknowledgment of the joint or separate DL/UL beam indication. The TCI field codepoint may be a joint TCI state for both DL and UL, or may be separate, e.g., a pair of DL TCI state and UL TCI state, a DL TCI state (keep the current UL TCI state), or an UL TCI state (keep the current DL TCI state).

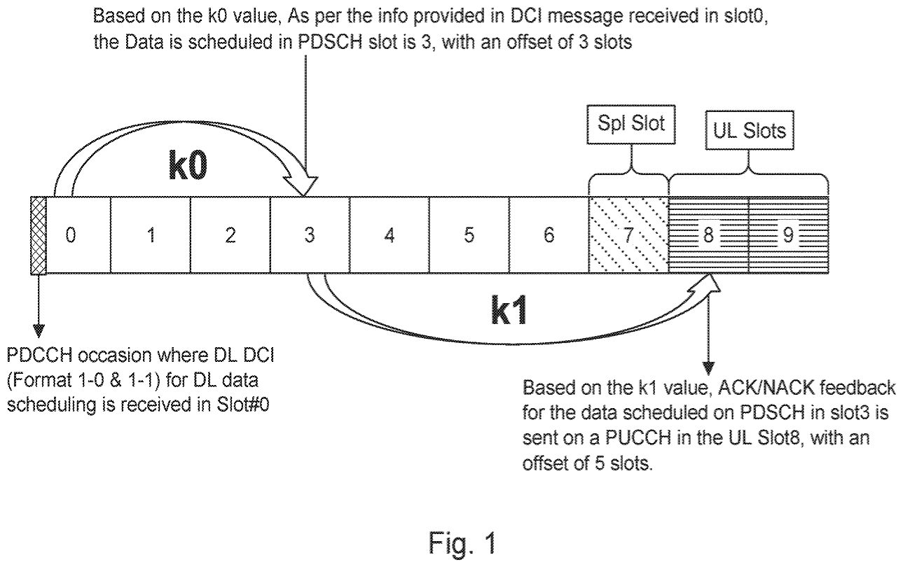

FIG. 1 illustrates an example of physical downlink shared channel (PDSCH) time domain allocation, according to an embodiment. In the example of FIG. 1, K0 is the offset between the DL slot where the PDCCH (DCI) for downlink scheduling is received and the DL slot where PDSCH data is scheduled. K1 is the offset between the DL slot where the data is scheduled on PDSCH and the UL slot where the ACK/NACK feedback for the scheduled PDSCH data need to be sent. In the example of FIG. 1, based on the K0 value, based on the information provided in the DCI message received in slot 0, the data is scheduled in PDSCH slot 3 with an offset of 3 slots. Based on the K1 value, ACK/NACK feedback for the data scheduled on PDSCH in slot 3 is sent on a physical uplink control channel (PUCCH) in the UL slot 8 with an offset of 5 slots.

When operating in time division duplex (TDD) mode, the UE needs to be aware of when to expect the transmission (UL) and when to expect the reception (DL) in terms of slots. In the 5G NR TDD slot pattern, unlike LTE, there are no predefined patterns. Rather, in NR, the pattern can be defined in a more flexible way based on below parameters and communicated to the UE via RRC reconfiguration message for NSA.

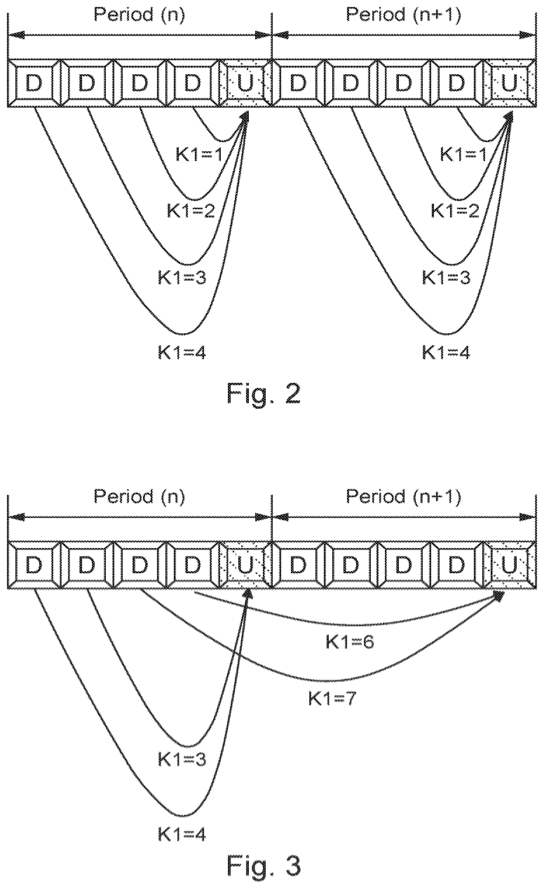

FIG. 2 illustrates an example of TDD pattern configuration, according to an example embodiment. In TDD NR, HARQ ACK/NACK timing is fully configurable. HARQ ACK/NACK timing can be configured for a specific PDSCH by specifying the parameter K1. As an example, assume that the slot configuration is DDDDU with 2.5 ms period. Then, the HARQ ACK/NACK for the PDSCH can be transmitted at the same UL slot by specifying Kl as shown in FIG. 2. In addition, FIG. 3 illustrates another example of flexible HARQ ACK/NACK timing.

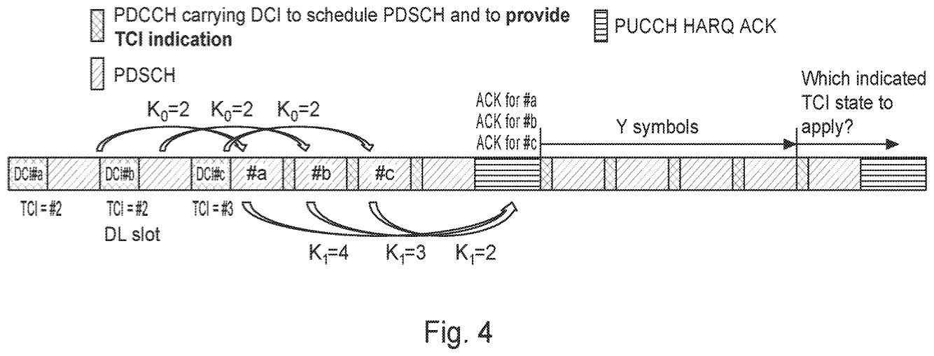

A problem may arise in relation to the application time of the beam indication (indicated TCI state) discussed above. The problem may be illustrated by the case where the in the same UL slot (the same UL channel like PUCCH or PUSCH) conveys HARQ-ACK information related to the multiple DCIs (and scheduled PDSCHs if DCI sent with DL assignment). Correspondingly, that means that there is the same application time for the different DCIs that may carry different indicated TCI states. Thus, there is ambiguity in which TCI state is to be applied after the application time of Y symbol after the PUCCH transmission, as illustrated in the example of FIG. 4. In other words, FIG. 4 depicts the ambiguity in which TCI indication the UE applies for the same application time. In the example of FIG. 4, DCI #a and DCI #b are carrying TCI state #2 while DCI #c is carrying TCI state #3. The PUCCH is then transmitting HARQ-ACK info corresponding to these three mentioned DCIs (and their scheduled PDSCHs). As acknowledge information for DCI #a, DCI #b and DCI #c is transmitted in a same slot, it is unclear which TCI state (indicated by which DCI) is to be applied.

According to an example embodiment, the UE may be configured to apply the indicated TCI state after Y symbols after the last symbol of the acknowledgment of the joint or separate DL/UL beam indication. In an embodiment, the Y symbols may represent the number of time domain OFDM symbols, where Y can be subcarrier spacing specific and may be equal to or greater than the value provided by the UE as UE capability. The indicated TCI state may be the one that was indicated in the latest (i.e., newest) DCI among the DCIs for which the UE transmits HARQ-ACK information in the same symbol or in the same UL slot or in the same uplink channel. The latest DCI is denoted as first DCI in later description. In one embodiment, the first DCI is the one for which the UE sends either HARQ-ACK or HARQ-NACK. According to another embodiment, the first DCI is the one for which the UE sends HARQ-ACK.

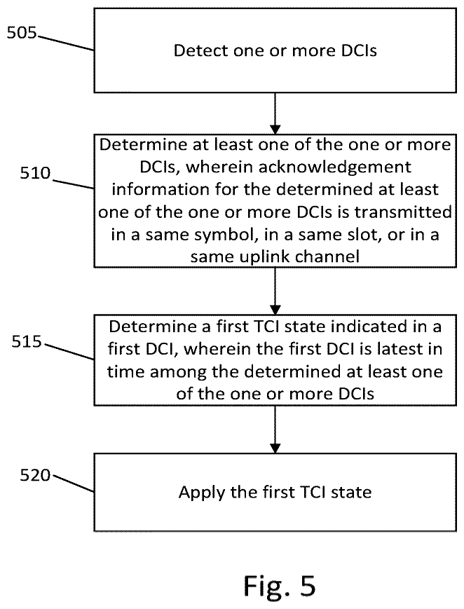

FIG. 5 illustrates an example flow diagram of a method of beam switching, according to an example embodiment. For instance, the method of FIG. 5 may solve ambiguity in beam application time, for example, in unified TCI framework. In certain example embodiments, the flow diagram of FIG. 5 may be performed by a communication device in a communications system, such as LTE or 5G NR. For instance, in some example embodiments, the communication device performing the method of FIG. 5 may include a UE, sidelink (SL) UE, wireless device, mobile station, IoT device, UE type of roadside unit (RSU), other mobile or stationary device, or the like.

As illustrated in the example of FIG. 5, at 505, a UE may detect one or more DCIs, with or without DL scheduling. In an embodiment, the method may include, at 510, determining at least one of the one or more DCIs and/or scheduled PDSCHs for which the UE is to transmit acknowledgement information, such as HARQ-ACK or HARQ negative-acknowledgement (NACK), information in the same symbol, in the same slot and/or in the same UL channel. For instance, the UL channel may include a PUCCH and/or PUSCH. According to an embodiment, the method may include, at 515, determining a first TCI state indicated in a first DCI, where the first DCI is latest in time among the DCIs determined at 510. In one embodiment, the first DCI may include a DCI for which the UE sends either HARQ-ACK or HARQ-NACK. In a further embodiment, the first DCI may include a DCI for which the UE sends HARQ ACK.

In certain embodiments, the method of FIG. 5 may further include, at 520, the UE applying the first TCI state determined at 515. According to one example embodiment, the applying 520 may include the UE applying the first TCI state after an application time. The application time may refer to the allowed processing time at the UE and/or gNB after the UE has sent HARQ-ACK. After the application time, the new indicated TCI state can be applied.

In an embodiment, the applying 520 of the first TCI state may include applying the first TCI state after a number of symbols (Y) or a number of slots after a last symbol of the acknowledgment information for the first DCI. In certain embodiments, the number of symbols (Y) or number of slots may be equal to or greater than a value provided by the UE as UE capability.

According to one example embodiment, referring to FIG. 4, there are three DCIs whose ACK/NACKs are transmitted in the same slot, i.e., DCI #a, DCI #b and DCI #c. Then DCI #c indicating TCI state #3 may be latest in time among all three DCIs. Therefore, in this example, the UE may consider TCI state #3 is to be applied after a number of symbols (Y) or a number of slots after the last symbol of ACK for DCI #c.

Also, in another example embodiment, referring to FIG. 4 with three DCIs (i.e., DCI #a, DCI #b and DCI #c) whose ACK/NACKs are transmitted in the same slot as above example. If acknowledgement information for DCI #a and DCI #b indicating TCI state #2 are both ACK, but acknowledgement information for DCI #c indicating TCI state #3 is NACK, then the UE may just consider DCIs with ACK when determining the first TCI state. Thus, according to this example embodiment, the UE may apply TCI state #2 indicated by DCI #b after a number of symbols (Y) or a number of slots after last symbol of ACK for DCI #b, as DCI #b is latest among DCI #a and DCI #b.

In an example embodiment, the network or gNB might not be allowed to have different TCI in DCIs for which there is the same time instant for the acknowledgement (e.g., HARQ-ACK) information in UL. Correspondingly, in one example embodiment, the UE can assume that there is no different TCI in the DCIs for which the UE transmits acknowledgement (e.g., HARQ-ACK) information at the same time (or on the same UL channel).

It is noted that FIG. 4 and FIG. 5 are provided as some example embodiments of a method or process. However, certain embodiments are not limited to these examples, and further examples are possible as discussed elsewhere herein.

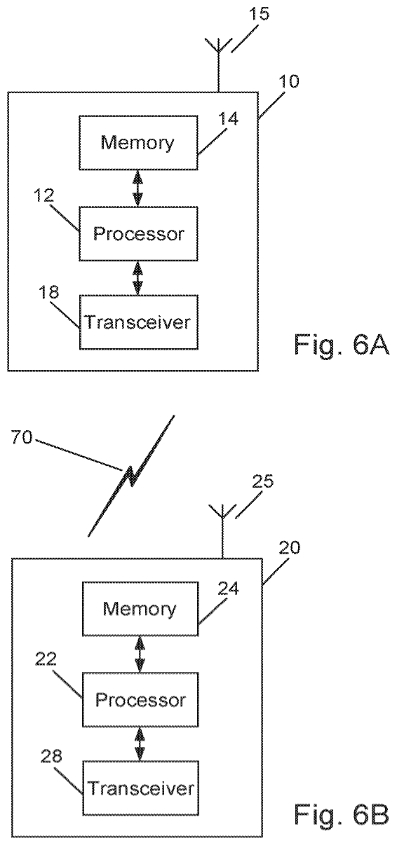

FIG. 6A illustrates an example of an apparatus 10 according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some ex ample embodiments, apparatus 10 may comprise an edge cloud server as a distributed computing system where the server and the radio node may be stand-alone apparatuses communicating with each other via a radio path or via a wired connection, or they may be located in a substantially same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 6A.

As illustrated in the example of FIG. 6A, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 6A, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an example embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some example embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an example embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some example embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain example embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1-5, or any other method described herein. In some embodiments, as discussed herein, apparatus 10 may be configured to perform a procedure relating to beam switching, e.g., that can solve ambiguity in beam application time in a unified TCI framework, for example.

FIG. 6B illustrates an example of an apparatus 20 according to another embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 6B.

As illustrated in the example of FIG. 6B, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 6B, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some example embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 1-2, or any other method described herein. For example, in an embodiment, apparatus 20 may be controlled to perform a process relating to beam switching, e.g., that can solve ambiguity in beam application time in a unified TCI framework, as described in detail elsewhere herein.

According to an embodiment, apparatus 20 may be controlled by memory 24 and processor 22 to detect one or more DCIs, and to determine at least one of the one or more DCIs, where acknowledgement information, such as HARQ-ACK or HARQ-NACK, for the determined at least one of the one or more DCIs is transmitted in a same symbol, in a same slot or in a same UL channel (e.g., PUCCH and/or PUSCH). In one embodiment, apparatus 20 may be further controlled by memory 24 and processor 22 to determine a first TCI state indicated in a first DCI that is latest in time among the determined at least one of the one or more DCIs. In an embodiment, apparatus 20 may be controlled by memory 24 and processor 22 to apply the first TCI state. According to an embodiment, apparatus 20 may be controlled to apply the first TCI state after an application time. In one example embodiment, the acknowledgement information for the first DCI may be a DCI for which the apparatus 20 sends either HARQ ACK or HARQ NACK. In a further example embodiment, the acknowledgement information for the first DCI may be a DCI for which the apparatus 20 sends HARQ ACK.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, sensors, circuits, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. For example, as discussed in detail above, certain example embodiments may be configured to provide methods, apparatuses and/or systems that enable beam switching. In particular, some embodiments therefore provide ways to solve ambiguity in beam application time in a unified TCI framework. Accordingly, the use of certain example embodiments results in improved functioning of communications networks and their nodes, such as base stations, eNBs, gNBs, and/or IoT devices, UEs or mobile stations, for instance.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations needed for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### PARTIAL GLOSSARY

ACK Acknowledgement
CSI-RS Channel State Information Reference Signal
DCI Downlink Control Information
HARQ Hybrid Automatic Repeat Request
L1-RSRP Layer 1 Reference Signal Received Power
NACK Negative Acknowledgement
PDCCH Physical Downlink Control Channel
PDSCH Physical Downlink Shared Channel
PUCCH Physical Uplink Control Channel
PUSCH Physical Uplink Shared Channel
QCL Quasi Co-location
SCS Subcarrier Spacing
SSB Synchronization Signal Block
TCI Transmission Configuration Indicator
UE User Equipment

1-20.(canceled)

21. A method, comprising:
detecting, by a user equipment, one or more downlink control information (DCIs);
determining, by the user equipment, at least one of the one or more downlink control information, wherein acknowledgement information for the determined at least one of the one or more downlink control information is transmitted in a same symbol, in a same slot or in a same uplink channel:
determining, by the user equipment, a first transmission configuration indicator state indicated in a first downlink control information, wherein the first downlink control information is latest in time among the determined at least one of the one or more downlink control information; and
applying, by the user equipment, the first transmission configuration indicator state.

22. The method of claim 21, wherein the acknowledgement information comprises a hybrid automatic repeat request acknowledgement or a hybrid automatic repeat request negative acknowledgement.

23. The method of claim 21, wherein acknowledgement information for the first downlink control information comprises either a hybrid automatic repeat request acknowledgement or a hybrid automatic repeat request negative acknowledgement.

24. The method of claim 21, wherein acknowledgement information for the first downlink control information comprises a hybrid automatic repeat request acknowledgement.

25. The method of claim 21, wherein the applying of the first transmission configuration indicator state comprises applying the first transmission configuration indicator state after a number of symbols or a number of slots after a last symbol of acknowledgment information for the first downlink control information.

26. An apparatus, comprising:
at least one processor: and
at least one memory comprising computer program code,
the at least one memory and computer program code configured, with the at least one processor, to cause the apparatus at least to perform:
detecting one or more downlink control information:
determining at least one of the one or more downlink control information, wherein acknowledgement information for the determined at least one of the one or more downlink control information is transmitted in a same symbol, in a same slot or in a same uplink channel:
determining a first transmission configuration indicator state indicated in a first downlink control information, wherein the first downlink control information is latest in time among the determined at least one of the one or more downlink control information: and
applying the first transmission configuration indicator state.

27. The apparatus of claim 26, wherein the acknowledgement information comprises a hybrid automatic repeat request acknowledgement or a hybrid automatic repeat request negative acknowledgement.

28. The apparatus of claim 26, wherein acknowledgement information for the first downlink control information comprises either a hybrid automatic repeat request acknowledgement or a hybrid automatic repeat request negative acknowledgement.

29. The apparatus of claim 26, wherein acknowledgement information for the first downlink control information comprises a hybrid automatic repeat request acknowledgement.

30. The apparatus of claim 26, wherein the applying of the first transmission configuration indicator state comprises applying the indicated transmission configuration indicator state after a number of symbols or a number of slots after a last symbol of acknowledgment information for the first downlink control information.

31. A computer readable medium comprising program instructions stored thereon for performing at least the following:
detecting one or more downlink control information:
determining at least one of the one or more downlink control information, wherein acknowledgement information for the determined at least one of the one or more downlink control information is transmitted in a same symbol, in a same slot or in a same uplink channel:
determining a first transmission configuration indicator state indicated in a first downlink control information, wherein the first downlink control information is latest in time among the determined at least one of the one or more downlink control information; and
applying the first transmission configuration indicator state.

32. The computer readable medium of claim 31, wherein the acknowledgement information comprises a hybrid automatic repeat request acknowledgement or a hybrid automatic repeat request negative acknowledgement.

33. The computer readable medium of claim 31, wherein acknowledgement information for the first downlink control information comprises either a hybrid automatic repeat request acknowledgement or a hybrid automatic repeat request negative acknowledgement.

34. The computer readable medium of claim 31, wherein acknowledgement information for the first downlink control information comprises a hybrid automatic repeat request acknowledgement.

35. The computer readable medium of claim 31, wherein the applying of the first transmission configuration indicator state comprises applying the first transmission configuration indicator state after a number of symbols or a number of slots after a last symbol of acknowledgment information for the first downlink control information.
